(19) United States
(12) Patent Application Publication
(10) Pub. No.: US 2013/0159039 A1
(43) Pub. Date: Jun. 20, 2013

(54) DATA CENTER INFRASTRUCTURE MANAGEMENT SYSTEM FOR MAINTENANCE

(71) Applicants: Brad L. Brech, Rochester, MN (US); Kenneth T. Gamdon, Erie, CO (US); Bret W. Lehman, Raleigh, NC (US); Christopher L. Molloy, Raleigh, NC (US)

(72) Inventors: Brad L. Brech, Rochester, MN (US); Kenneth T. Gamdon, Erie, CO (US); Bret W. Lehman, Raleigh, NC (US); Christopher L. Molloy, Raleigh, NC (US)

(73) Assignee: INTERNATIONAL BUSINESS MACHINES CORPORATION, Armonk, NY (US)

(21) Appl. No.: 13/326,412

(22) Filed: Dec. 15, 2011

(51) Int. Cl. G06Q 10/06

(52) U.S. Cl. 705/7.15

(57) ABSTRACT

A change management system issues work tickets that list particular procedures for performing an action, for example, in a data center. If these procedures are not followed precisely, then an outage may occur. Advantageously, the change management system may be communicatively coupled to an infrastructure management system for verifying that the procedures were performed properly. For any work ticket that involves support devices (e.g., power supplies or cooling mechanisms) that are monitored by the infrastructure management system, the change management system may send a request to the infrastructure management system to verify that these support devices are in the correct mode or state. If not, the change management system may refuse to close the ticket and instruct a technician to change the support device to the proper condition. This may prevent outages that occur from a technician failing to follow the procedures detailed by the change management system.

### BACKGROUND

A data center may be defined as a location that houses numerous IT devices that contain printed circuit (PC) board electronic systems arranged in a number of racks. A standard rack may be configured to house a number of PC boards, e.g., about forty boards. The PC boards typically include a number of components, for example, processors, micro-controllers, high-speed video cards, memories, semiconductor devices, and the like. A typical PC board comprising multiple microprocessors may consume approximately 250 W of power. Thus, a rack containing forty PC boards of this type may consume approximately 10 KW of power.

Many types of support devices are located within data centers to provide the necessary power and cooling for the IT devices. Power distribution units (PDU), uninterruptible power supplies (UPS), and cooling systems (e.g., computer room air conditioning unit (CRAC)) are examples of data center support devices. If these devices fail, the data center may experience a system outage. For example, if a PDU fails, all the connected IT devices that rely on the power provided by the PDU similarly fail.

### SUMMARY

Embodiments of the invention provide a method and computer program product for monitoring a data center. The method and computer program include issuing a work ticket from a change management system, the work ticket comprising a procedure that alters a condition of a support device in the data center. The method and computer program include determining, by one or more computer processors in a computing device, a condition of a support device in the data center where the support device is one of a plurality of devices in a support infrastructure system of the data center that support the functionality of one or more IT devices in the data center. Moreover, the support device is coupled to the computing device. If the condition of the support device is not a desired condition, the method and computer program transmit an alert. Upon determining that the procedure was completed, the method and computer program close the work ticket.

Embodiments of the invention provide a system that includes a change management system, a support device in a data center, and a computing device. The change management system is configured to issue a work ticket, the work ticket comprising a procedure that alters a condition of a support device in the data center. The support device is one of a plurality of devices in a support infrastructure system of the data center that support the functionality of one or more IT devices in the data center. The computing device is configured to determine a condition of a support device in the data center, where the support device is coupled to the computing device. If the condition of the support device is not a desired condition, the computing device is configured to transmit an alert. Upon determining that the procedure was completed, the change management system is configured to close the work ticket.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 is a system for managing the support devices in a data center, according to one embodiment of the invention.

FIG. 2 is a system for managing a support device in the data center of FIG. 1, according to one embodiment of the invention.

FIG. 3 is a flow diagram for managing support devices in a data center, according to one embodiment of the invention.

FIG. 4 is a flow diagram for managing support devices in a data center, according to one embodiment of the invention.

### DETAILED DESCRIPTION

A data center may be conceptually divided into IT devices and support devices. The IT devices are tasked with moving, storing, and manipulating data in response to client user requests that are received at the data center. IT devices include servers, storage devices, network devices, and the like. Support devices, in contrast, are tasked with providing the infrastructure necessary to operate the IT devices, such as power or environmental control. The support devices support the functionality of the IT devices by providing power (or power protection) or controlling the environment of the data center. Support devices include PDUs, UPSs, cooling devices, and the like.

The IT devices are usually coupled to create one or more LANs within in the data center which may communicate with other larger networks (i.e., the Internet). Similarly, the support devices may also be communicatively linked such that one or more central computing devices can monitor the status, mode of operation, or service requests related to the support devices. This network may be within the network for the IT devices or in a separate, independent network.

Administrators of data centers typically use a change management system (CMS) for maintaining or altering the data center. In general, change management ensures that standardized methods and procedures are used for efficient and prompt handling of changes made to the IT devices (i.e., the IT infrastructure) in a data center. Following the procedures outlined by a CMS minimizes the number and impact of errors that may affect service. However, a CMS is limited by how well personnel (e.g., a technician) follow the provided procedures. If the procedure is not followed precisely, one or more of the IT devices may fail and cause an outage. As used herein, an “outage” includes a network outage where a portion of the data center that responds to client requests is offline, a power outage, a maintenance outage from support devices failing, and the like.

For example, a server may be redundantly connected to two PDUs. If one of these PDUs fails, the CMS may provide a procedure that requires a technician to switch the malfunctioning PDU from the operating mode to the maintenance mode, change the failed component, and switch the PDU back to the operating mode. If this procedure is followed, power is continuously provided to the server. However, an outage may occur if the technician performs the service on the wrong PDU. For example, the technician may mistakenly change the operating mode of the functioning PDU to the maintenance mode. Thus, neither PDU is supplying power to the server which may cause an immediate outage to occur (i.e., at least a portion of the network established by the IT devices is unavailable). Alternatively, the technician may change the failed component on the correct PDU but forget to change its mode back to “operating” rather than “maintenance.” Here, if the other PDU fails, then the PDU that is still in maintenance mode cannot supply power to the server which may cause an outage. This is an example of delayed outage that may occur from the failure of technician to follow the procedures outlined by the CMS.

Instead of relying on the technician to report whether a change in the data center has been properly performed, the CMS may be linked with a data center infrastructure management system (IMS) to verify that the CMS procedure was properly carried out. As mentioned previously, the support devices may be communicatively coupled to create a network that may be managed by the IMS. Through it, technician can monitor the status, mode of operation, or service requests related to the support devices. When the CMS identifies a need for maintenance, it may also inform the IMS. The IMS may instruct the relevant support device to provide the technician with a visual cue (e.g., a blinking light) so that the technician identifies the correct support device. This action may prevent the technician from powering-down the wrong support device, thereby causing an immediate outage.

After the technician performs the required maintenance and before the CMS closes a work ticket or a service ticket (i.e., the CMS certifies that the maintenance was completed) the CMS may wait for verification from the IMS. Because the IMS is capable of monitoring the mode or status of the support device, it can ensure the support device is in the correct state, for example, the support device was returned to the operating mode. This verification process may prevent delayed outages. Thus, a data center with the CMS and IMS communicatively coupled can prevent many outages that may occur from human error.

Alternatively, the IMS may prevent human error without being communicatively coupled to the CMS. The IMS may monitor the different connected support devices to determine when they deviate from their normal operation. This deviation may occur, for example, if the devices malfunction, their modes are changed to perform maintenance, or their status is affected by changing conditions in the data center. After detecting a change in the support device, the IMS may wait for a period of time to determine whether the device returns to a normal condition. The threshold may be set based on the type of support device or on the change that occurred. Once the time threshold has expired and the device has not returned to a normal state, the IMS may alert a system administrator. For example, even if the CMS and IMS were not coupled, if a technician failed to return the mode of a PDU back to “operating” as instructed by the CMS, the IMS could detect that the PDU was in a maintenance mode and, after the time period has expired, alert the technician. Thus, even though the CMS and IMS may not be directly linked, the IMS may still verify that the procedures outlined by the CMS are followed.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the IMS or CMS) or related data available in the cloud. For example, the IMS could execute on a computing system in the cloud and monitor the different support devices in a data center. In such a case, the IMS could be executed on a computing device within the cloud network. Doing so allows a user to access the IMS from any computing system attached to a network connected to the cloud (e.g., the Internet).

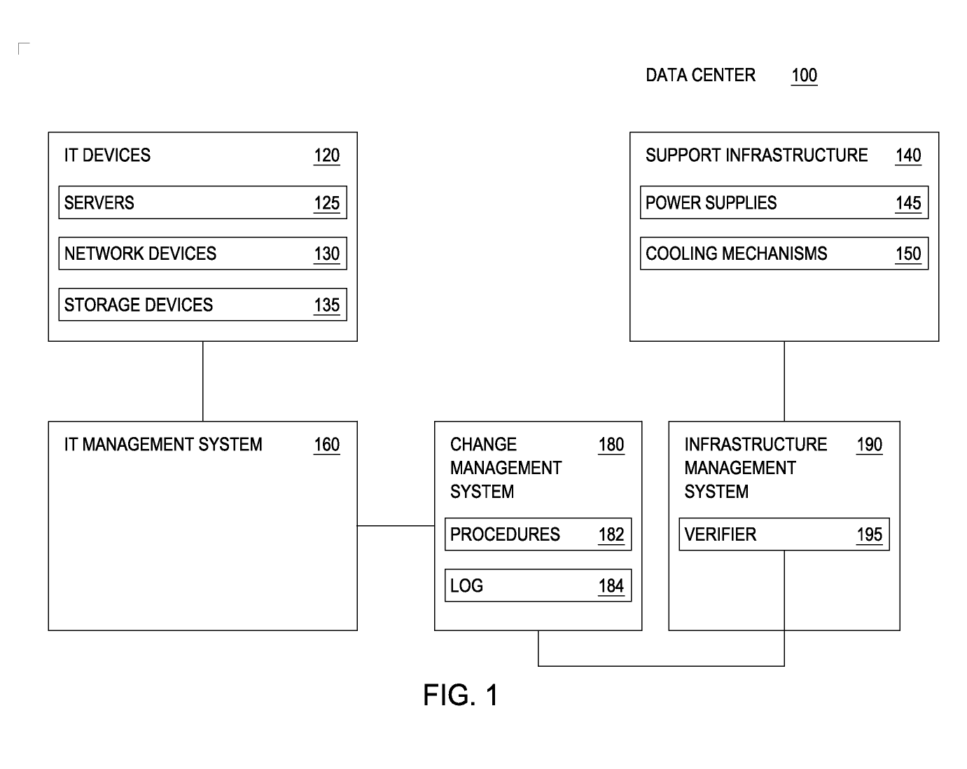

FIG. 1 is a system for managing the support devices in a data center, according to one embodiment of the invention. As shown, the data center 100 includes IT devices 120, support infrastructure 140, an IT management system (ITMS) 160, a CMS 180 and an IMS 190.

The IT devices 120 may include servers 125, network devices 130, and storage devices 135. The servers 125 are generally any computing device that serves to fulfill the request of other programs (i.e., a client-server architecture). For example, the servers 125 may be any computing device that modify, store, or retrieve data per the client's (e.g., an application) requests. Furthermore, in one embodiment, the client request may originate from a location outside of the data center 100.

The network devices 130 may include switches, routers, bridges, and the like which are connected to the servers 125 to establish a network (e.g., a LAN) on which the servers 125 may transfer data. The network devices 130 may also provide access to a WAN such as the Internet. Accordingly, the network devices 130 may receive the client requests via the Internet and forward the requests to the relevant server 125.

The storage devices 135 may expand the storage capabilities of the servers 125. The servers 125 may, using the network established by the network devices 125 or by a direct connection, store data in and retrieve data from the storage devices 135. Example of storage devices 135 include solid-state drives, hard disk drives, tape drives, and the like.

Although not shown, the IT devices 120 may contain other peripheral IT elements that aid in transporting and modifying the data necessary to fulfill client requests. These elements may include I/O devices such as printers, keyboards, video monitors, and the like which may permit a system administrator to access and control the IT devices 120.

The support infrastructure system 140 includes devices located in or near the data center 100 that provide necessary support to the IT devices 120. That is, the devices in the support infrastructure system 140 support the functionality of IT devices 120 by, for example, providing power to the IT devices 120 or ensuring that the components within the IT devices 120 do not overheat. Although the devices in the support infrastructure 140 may be connected to an IT device, in one embodiment, the support devices may not transport or modify the data associated with client requests that are processed by the IT devices 120. Thus, the support infrastructure 140 may form a separate, independent network for controlling and monitoring the support devices. Alternatively, the support devices may be communicatively coupled to the same network used by the IT devices 120 (i.e., the support devices may be connected to the network devices 130) but the data associated with the support devices may be treated as a separate network. That is, the support devices may piggy-back off of the connectivity provided by the network devices 130. Nonetheless, the network devices 130 may establish two separate networks (e.g., virtual networks) such that the data associated with the client requests submitted to the data center 100 are not transmitted to the support devices in the support infrastructure 140.

The support infrastructure system 140 includes power supplies 145, cooling mechanisms 150, and the like. The power supplies 145 may include PDUs, UPSs, and the like which provide power to an IT device in the data center 100. The cooling mechanisms 150 may include any kind of fluid-cooling device, whether liquid or air. A rear-door heat exchanger is an example of a liquid-based cooling mechanism, while a CRAC is an example of air-based cooling mechanism 150. The fan speed or pump pressure of the cooling mechanisms 150 may be controlled, thereby affecting the temperature of the data center 100. Moreover, the cooling mechanisms 150 may include any device that alters the environment of the data center to achieve a desired temperature, humidity, pressure, etc.

In general, the power supplies 145 and cooling mechanisms 150 may include a communication port (e.g., an Ethernet port) that connects the support device to a different computing device. Using these ports, the support infrastructure 140 may be communicatively coupled to, and monitored by, the IMS 190.

The ITMS 160, CMS 180, and IMS 190 are applications that control or monitor the IT and support devices in the data center 100. These applications may be executed on one or more computing devices that are located in, or remotely from, the data center 100. For example, if the support infrastructure 140 is connected to the network devices 130, the network devices 130 may transmit updates concerning the support devices to the IMS 190 via a WAN.

The ITMS 160 may monitor and control the different IT devices 120. For example, the ITMS 160 may balance the workload amongst the servers 125, monitor the temperature of the hardware elements in the devices 120, or monitor the devices' performances.

The CMS 180 includes procedures 182 and a log 184. Each procedure 182 provides a step-by-step process which, when followed, informs a technician how to correctly perform an action. The log 184 is maintained by the CMS 180 to record what actions were performed and when those actions were completed. In one embodiment, the log 184 may include a list of work tickets. When the CMS 180 identifies an action to be performed or when an administrator requests that an action be performed, the CMS 180 may open a work ticket. A technician is assigned the ticket, and after performing the procedure 182 associated with the work ticket, informs the CMS 180 to close the ticket. The log 184 may store these tickets as a record of the changes made to the data center.

Each procedure 182 corresponds to at least one action. The procedure 182 details a list of tasks (i.e., sub-actions) to accomplish the desired action. An action may include, for example, changing the physical layout of the IT devices 120 or the support infrastructure 140, modifying the connections between the devices, adding new devices, performing maintenance, troubleshooting malfunctioning devices, and the like. One of ordinary skill will recognize the different actions that may have corresponding procedures 182 in the CMS 180.

In one embodiment, the CMS 180 and ITMS 160 may be combined to create a management stack such as in Tivoli® Management stack. Doing so permits the CMS 180 to communicate with the ITMS 160 to determine if an action was properly carried out on an IT device. For example, if the CMS 180 created a work ticket to upgrade the software on a particular server, once a technician reported to the CMS 160 that the upgrade was completed, the ITMS 160 could then communicate with the server to determine if the currently executed software is the correct release. In this manner, the ITMS 160 can verify that the action was carried out for the IT devices 120. Furthermore, by connecting the CMS 180 to the IMS 190, a similar verification process may be performed for the devices in the support infrastructure 140.

The IMS 190 monitors the different devices in the support architecture 140. The IMS 190 may be connected to the devices using typical communication methods such as Ethernet ports and cables. Moreover, the support devices may be interconnected to form a separate LAN using network devices (routers, switches, etc.) that may be the same as network devices 130 or different, additional network devices. Using these connections, the IMS 190 may monitor the support devices to determine their mode of operation or status. The IMS 190, for example, may detect that a PDU has changed from the operating mode to maintenance mode or if the PDU is malfunctioning because of a blown fuse.

In one embodiment, the IMS 190 is also able to control one or more functions of the support devices. For example, the IMS 190 may be able to transmit messages that are displayed on LCD panels on the support devices or activate a visual indicator (e.g., a flashing light) on the device. Further, the IMS 190 may be able to control the support devices by remotely changing their modes or states.

The IMS 190 includes a verifier 195 which may communicate with the CMS 180 to make ensure that an action was completed. As shown, the verifier 195 is communicatively coupled to the CMS 180. After a technician informs the CMS 180 that a work ticket is completed, the CMS 180 may transmit a message to the verifier 195 to make sure that all of support devices that were affected by the work ticket have the correct mode or status. If so, the verifier 195 may respond in the affirmative thereby permitting the CMS 180 to close the work ticket. Otherwise, the verifier 195 may transmit a message to the CMS 180 with the details of one or more tasks in the work ticket that were not completed—e.g., a latch holding an air filter in a CRAC was not properly closed.

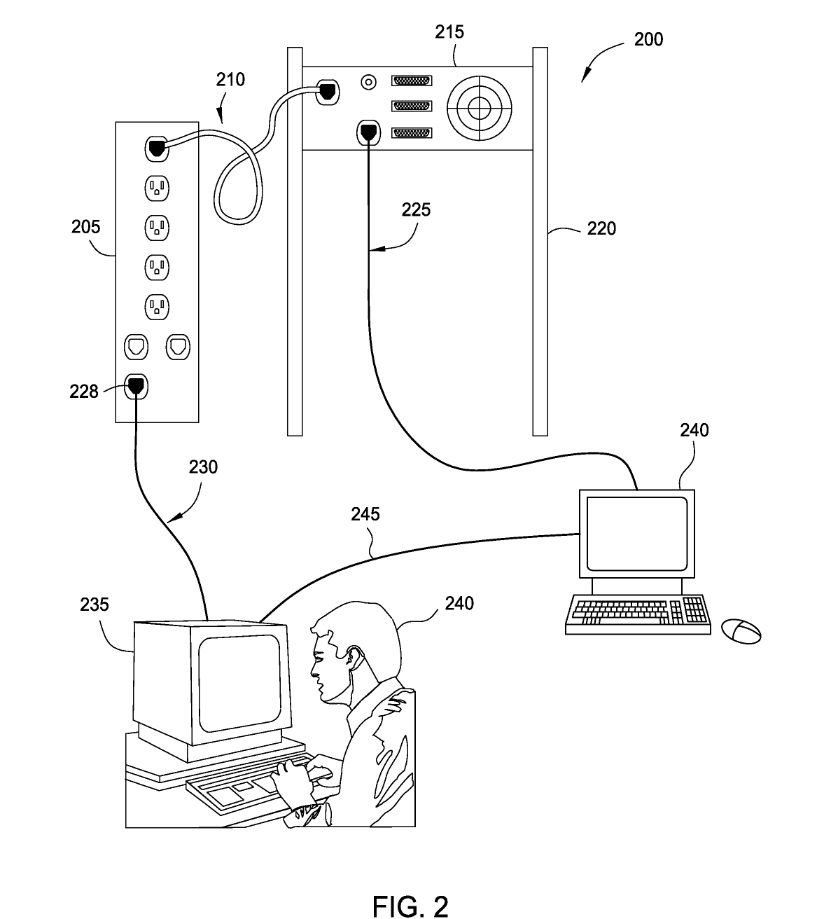

FIG. 2 is a system for managing a support device in the data center of FIG. 1, according to one embodiment of the invention. The system 200 includes a subset of the different elements that may be in data center 100. As shown, the system 200 includes PDU 205, server 215, rack 220 and computing device 235. The PDU 205 (i.e., a power supply 145) includes a plurality of connectors to which a power cable 210 may attach. Using the power cable 210, the PDU 205 provides power to the server 215 (i.e., an IT device 120). The rack 220 may include a plurality of servers 215 that each may be connected to two PDUs 205 to provide redundant power in case one of the PDUs 205 fails. The PDU 205 may also include a communication port 228 that is connected to a communication cable 230. In one embodiment, the communication port 228 and cable 230 may be compatible with the Ethernet communication standard. Alternatively, instead of a cable 230, the PDU 205 may have the necessary hardware elements for wireless communication.

The PDU 205 may include a network adapter for transmitting data to and receiving data from the computing device 235. Moreover, instead of the cable 230 directly connecting the PDU 205 and computing device, the cable 230 may connect the PDU 205 to one or more network devices to create a LAN. All the different support devices in the support infrastructure 140 may be connected either directly or indirectly (via the network devices) to the computing device 235.

Similarly, the server 215 is connected to the computing device 240 via cable 225. Moreover, other IT devices 120 may have similar connections to the computing device 240. As such, these connections may make up a LAN that is different than the LAN used to service client requests as discussed above. Instead, the LAN shown in FIG. 2 may be used specifically for communicating with the ITMS 160.

The computing device 240 may be executing the ITMS 160 and CMS 180 applications. Via the cable 225, the ITMS 160 can control the workload of the server 215, monitor the temperature of the hardware elements in the server 215, monitor the performance of the server 215, and the like. Moreover, a technician 240 may use the computing device 240 to request that the CMS 180 open a work ticket. In response, the CMS 180 may display a procedure 182 for the technician 240 to follow. If the procedure affects an IT device (e.g., server 215) the CMS 180 may request that the ITMS 160 verify that the technician completed the procedure 182 correctly.

The computing device 235 may execute the IMS 190 application. The PDU 205 may transmit updates to the IMS 190 which then displays the information to a technician 240. Moreover, the computing devices 235 and 240 may be communicatively coupled as shown by wire 245. In this manner, the IMS 190 and CMS 180 applications may be able to communicate. As such, when the CMS 180 opens a ticket that involves a support device, the CMS 180 may use the IMS 190 to ensure the procedure 182 was followed correctly.

One of ordinary skill will note the different arrangement and communication methods that may be employed to establish system 200. For example, wireless signals and different network devices may implemented as well as consolidating the applications onto only one computing device.

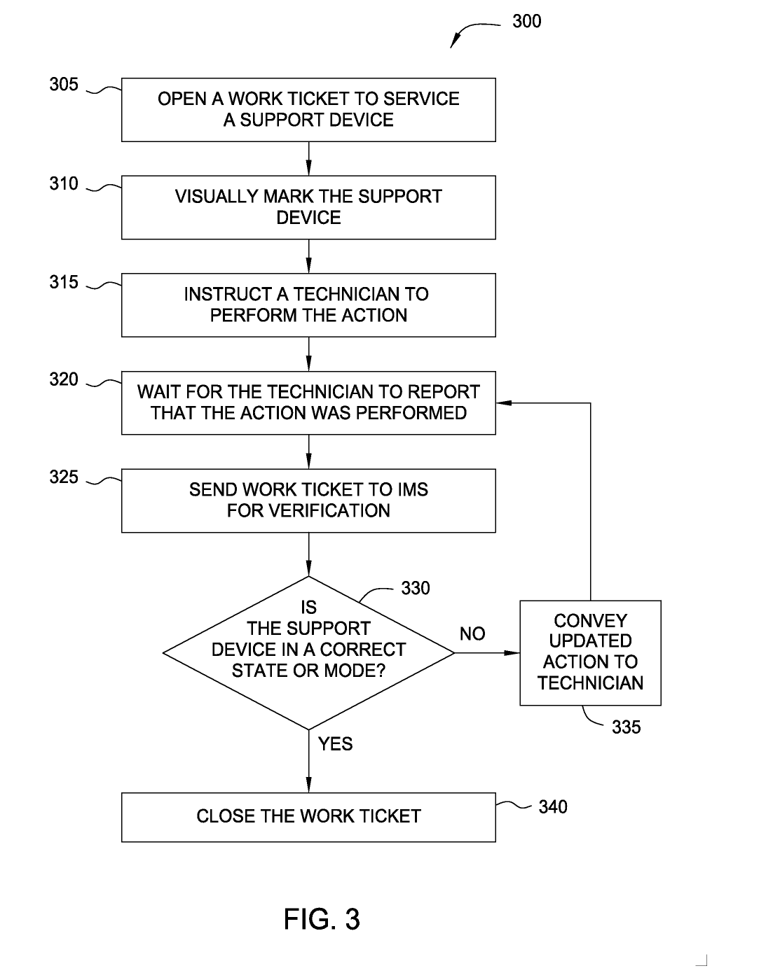

FIG. 3 is a flow diagram for managing support devices in a data center, according to one embodiment of the invention. At step 305, the CMS 180 opens a work ticket to perform a certain action or service. The CMS 180 may generate the work ticket either based on a request from an administrator or automatically. For example, an administrator may want to move a CRAC to a different location in the data center 100 and may submit a request to the CMS 180. Alternatively, the CMS 180 may automatically generate a ticket based on scheduled maintenance or if the ITMS 160 or IMS 190 identify a malfunctioning device.

As mentioned previously, the work ticket is associated with a procedure 182 that lists the different steps that should be taken to properly carry out the action. For example, moving a CRAC may first entail powering down IT devices that are cooled by the CRAC (to prevent them from over-heating) and connecting spare IT devices to the data center 100 to substitute for the disconnected devices. Only after these steps of the procedure 182 are performed can the technician power down the CRAC and move it to a different location.

At step 310, the CMS 180 may identify any support devices associated with the work ticket and transmit a request to the IMS 190 for the IMS 190 to visually mark the support device (or devices). As shown in FIG. 2, the CMS 180 and IMS 190 may be configured such that they can communicate. Moreover, the IMS 190 may be connected to one or more support devices. To prevent immediate outages from, for example, a technician powering down the wrong support device, the IMS 190 may transmit a message to the correct support device that instructs it to display a visual mark or indicator. In one embodiment, the support device may include an integrated screen that can display messages. The IMS 190 could instruct the support device that should be worked on by the technician to display the work ticket number, for example. In another embodiment, the visual mark could be a light on the support device to alert the technician that it is the relevant device.

At step 315, the CMS 180 may issue the work ticket to the technician. This may be performed by emailing the ticket, displaying it on a monitor, printing out the ticket, waiting for the technician to log in to the CMS 180, and the like. This invention is not limited to any particular method of informing a technician of a work ticket.

At step 320, the CMS 180 waits for the technician to complete the procedure outlined in the ticket. Because the work ticket may require a technician to perform at least one of the steps of the work ticket—e.g., physically replacing a fuse—the CMS 180 relies on the technician to inform the application when at least that step is completed. Thus, in one embodiment, the work ticket includes one task that must be completed by a human technician. However, the embodiments disclosed herein are not limited to waiting for a human to perform one or more tasks in a work ticket procedure. Instead, the CMS 180 may wait for a separate system to perform a task. For example, the CMS 180 may wait for the ITMS 160 to restart a particular server. Regardless of the entity carrying out the work ticket, the CMS 180 waits until that entity informs the CMS 180 that the task was completed.

At step 325, if the work ticket requires that a support device be modified, the CMS 180 may relay a message to the IMS 190 that the work ticket was reported as being completed. Because at step 320 the CMS 180 relied on a separate entity, whether a human or a separate electronic system, the CMS 180 may use the IMS 190 to confirm that the steps in the work ticket were performed correctly. As shown in FIGS. 1 and 2, the IMS 190 may be connected to various support devices in the support architecture 140. Accordingly, the IMS 190 may receive status updates from the different support devices. Based on the CMS 180 informing the IMS 190 of the altered support devices, the verifier 195 of the IMS 190 may then check the condition of those devices. For example, the verifier 195 may transmit a request to the support device asking it to inform the IMS 190 of its current status or mode.

At step 330, the verifier 195 of the IMS 190 compares the current status or mode of the support devices identified in the work ticket to the status or mode that the support device should be in according to the procedure 182 outlined in the work ticket. For example, the work ticket may stipulate that a PDU should be powered off at the end of the work ticket. If the verifier 195 discovers that the PDU is operational, the IMS 190 may transmit an alert to the CMS 180. If the technician failed to change the PDU from maintenance mode to operational mode, the IMS 190 may alert the CMS 180. If the work ticket instructed the technician to install a new CRAC in the data center 100 but the verifier 195 is unable to contact the new CRAC (perhaps the technician failed to attach the appropriate network cable into the CRAC), the IMS 190 may alert the CMS 180.

If the current mode or status of the support device matches the expected status or mode, then at step 340 the CMS 180 may close the ticket. The CMS 180, for example, may store the ticket into the log 184 along with the verification from the IMS 190 that the support device or devices have the correct mode or status.

If the current mode or status of the support device does not match the expected status or mode, then at step 335, the verifier 195 may send a failure message to the CMS 180 which, in turn, may not close the work ticket. Further, the IMS 190 may supply to the CMS 180 the specific support devices that did or did not have the correct mode or status. For example, if two PDUs that were altered during the work ticket have the correct status but a third does not, the IMS 190 may transmit this information to the CMS 180. Using this data, the CMS 180 may convey an updated action to the technician. This may be in the form of a new work ticket or follow-up item. Advantageously, the CMS 180 can inform the technician (or other entity) of the precise support device that needs to have an action performed. Continuing with the previous example, the CMS 180 would instruct the technician to check only the third PDU. In this manner, the technician does not have to repeat the entire procedure 182 in the old work ticket to identify the step that was not performed properly.

Once the technician receives the follow-up task identified by the IMS 190, the method 300 may return to step 320 and again wait for the technician to perform the task. Additionally, the CMS 180 may again use the IMS 190 to ensure the follow-up action was performed properly—i.e., steps 325 and 330.

In one embodiment, the IMS 190 may be capable of remotely changing the mode or state of the support device. Thus, instead of transmitting a follow-up task to the technician, the IMS 190 may change the mode to the desired state as stipulated in the work ticket without intervention from the technician. Furthermore, the method 300 may entail using the IMS 190 to change the mode of the support device before a technician begins to perform service on the device. Thus, the IMS 190 may change the support device from its “operating mode” to “maintenance mode”. This is one less step that must be performed by the technician and may reduce human error.

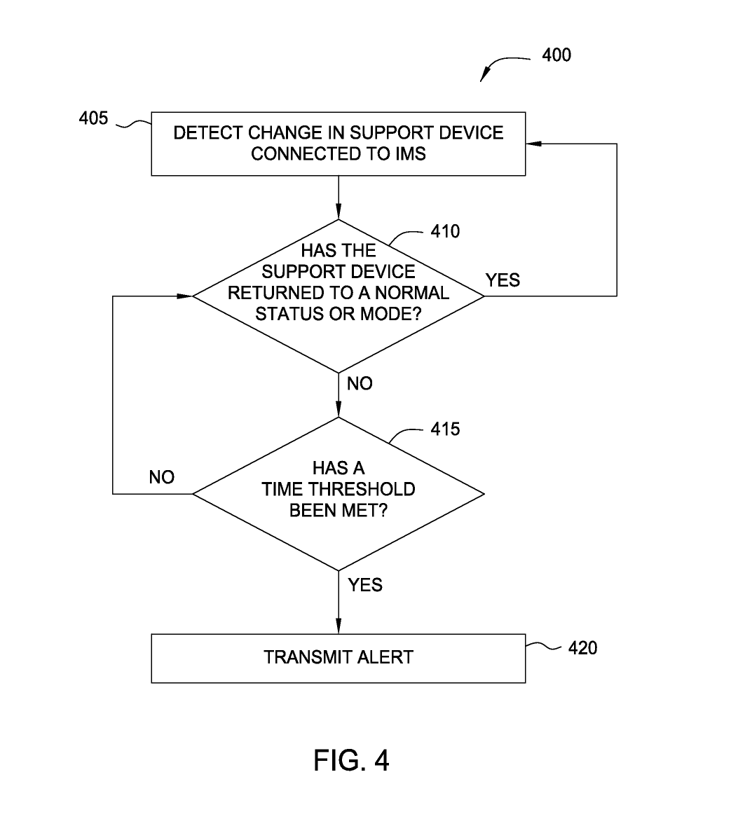

FIG. 4 is a flow diagram for managing support devices in a data center, according to one embodiment of the invention. Specifically, in one embodiment, the method 400 may be used when the CMS 180 and IMS 190 are not communicatively coupled. In contrast to method 300 of FIG. 3, in method 400 the CMS 180 may be unable to communicate with the IMS 190. Alternatively, in another embodiment, method 400 may used in addition to method 300—i.e., when the CMS 180 and IMS 190 are communicatively coupled.

At step 405, the IMS 190 detects a change in the status or mode of a support device. As discussed above, the IMS 190 may be attached to one or more support devices in the data center 100. The IMS 190 may poll or receive updates from the support devices to determine their status. A status change may include the support device powering down, the IMS 190 is no longer able to communicate with the device, detecting a malfunction, and the like. A mode change may occur when the support devices changes to a different state in response to, for example, a technician performing maintenance on the device or a certain condition being met, such as a power surge. In general, the IMS 190 detects any abnormalities or deviations from a normal, desired condition.

At step 410, the IMS 190 may continue to monitor the support device that has a status or mode that deviates from the desired condition. If the support device remains in an abnormal condition, at step 415, the IMS 190 determines whether a threshold time has elapsed. Because an abnormal condition does not necessary mean that a system administrator should be alerted, the threshold instructs the IMS 190 to wait to determine if the support device returns to a normal state or mode. For example, the mode may have been changed because a technician is servicing the device. If a technician typically requires five minutes to service a support device, the threshold may be set to some time period greater than this average time. Using a threshold minimizes the risk of the IMS 190 issuing the false positives. If the state or mode of the support device returns to normal, then the method 400 returns to step 405 to detect another change in a support device.

If the threshold elapses and the support device has not returned to a normal state, at step 420 the IMS 190 may transmit an alert. Doing so may help prevent delayed outages that may occur from, for example, human error. If a technician fails to change the mode of a PDU that is part of a redundant pair of PDUs from “maintenance” to “operating,” the IMS 190 may detect the abnormal condition and generate the alert.

In one embodiment, the IMS 190 may transmit the alert to a system administrator or technician. The technician may then start a new work ticket using the CMS 180 based on the alert from the IMS 190. In this manner, the CMS 180 and IMS 190 do not need to communicate directly for the IMS 190 to verify that maintenance on the support devices based on work tickets issued by the CMS 180 were performed properly.

In one embodiment, the method 400 may be used with the method 300 when the IMS 190 is communicatively coupled to the CMS 180. Once the time threshold has elapsed and the support device has not returned to normal, the IMS 190 may transmit the alert directly to the CMS 180. Once the CMS 180 receives the alert, it will not close the ticket. Moreover, the IMS 190 may continue to send the alert so long as the support device remains in the abnormal condition. However, once the IMS 190 determines at step 410 that the support device has returned to a normal mode or status, the IMS 190 may stop sending the alert thereby indicating to the CMS 180 that the ticket can be closed. The CMS 180 may further wait until the technician indicates the she has completed the work ticket. Once these two conditions are met, the CMS 180 may close the work ticket.

In one embodiment, the time threshold may be adjusted based on the status or mode that was changed. Moreover, for some abnormal behavior, the method 400 may not use any kind of time threshold. If, for example, the IMS 190 detects that a blown fuse has caused a UPS to malfunction, the IMS 190 may immediately send an alert. However, if the abnormal condition is based on something that is typically caused by human error—e.g., the UPS is in maintenance mode or a container is not fully shut—the time threshold may be used to give the technician enough time to fix the problem on his own before sending an alert. If the problem typically requires more time to fix, the threshold may be increased to give the technician more time to service the device and return its condition to normal.

### CONCLUSION

A CMS issues work tickets that list particular procedures for performing an action, for example, in a data center. If these procedures are not followed precisely, then a outage may occur. Advantageously, the CMS may be communicatively coupled to an IMS for verifying that the procedures were performed properly. For any work ticket that involves support devices (e.g., power supplies or cooling mechanisms) that are monitored by the IMS, the CMS may send a request to the IMS to verify that these support devices are in the correct mode or state. If not, the CMS may refuse to close the ticket and instruct a technician to change the support device to the proper condition. This may prevent outages that occur from a technician failing to follow the procedures detailed by the CMS.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

1. A method for monitoring a data center, comprising:
issuing a work ticket from a change management system (CMS), the work ticket specifies a procedure that alters a condition of a support device in the data center;
upon receiving a request from the CMS to confirm that the procedure was performed properly, determining, by one or more computer processors, the condition of the support device in the data center using an infrastructure management system (IMS) communicatively coupled to the support device, wherein the support device is one of a plurality of devices in a support infrastructure system of the data center that support the functionality of one or more IT devices in the data center;
if the IMS determines that the condition of the support device is not in a desired state after the procedure is performed, transmitting an alert from the IMS to the CMS; and
if the IMS determines that the condition of the support device is in the desired state after the procedure is performed, transmitting a verification message from the IMS to the CMS instructing the CMS to close the work ticket.

2. The method of claim 1, wherein the IT devices at least one of move, store, and manipulate data in response to client requests received at the data center.

3. The method of claim 1, further comprising:
receiving at the CMS a signal from a technician, the signal indicating that the procedure was performed;
upon receiving the signal, transmitting from the CMS to the IMS the request to confirm that the procedure was performed properly.

4. The method of claim 3, further comprising, before receiving the signal from the technician, displaying a visual indicator on the support device viewable to the technician that uniquely identifies the support device from the plurality of devices in the support infrastructure system.

5. The method of claim 1, further comprising, if the IMS determines that the condition of the support device is not the desired state, issuing a new work ticket from the CMS, the new work ticket comprising a new procedure for changing the condition of the support device to the desired state.

6. The method of claim 1, further comprising, if the IMS determines that the condition of the support device is not the desired state, changing the condition of the support device to the desired state using the IMS.

7. The method of claim 1, wherein the condition of the support device comprises at least one of: an operational mode of the support device and a functional status of the support device.

8. The method of claim 1, wherein the support device at least one of (i) provides power to an IT device in the data center configured to process data associated with a client request received at the data center and (ii) alters an environmental condition of the data center to achieve a desired value of the environmental condition.

9. A computer program product for monitoring a data center, the computer program product comprising:
a computer-readable storage memory having computer-readable program code embodied therewith, the computer-readable program code comprising computer-readable program code configured to:
issue a work ticket from a change management system (CMS), the work ticket specifies a procedure that alters a condition of a support device in the data center;
upon receiving a request from the CMS to confirm that the procedure was performed properly, determine, using an infrastructure management system (IMS) communicatively coupled to the support device, the condition of the support device in the data center, wherein the support device is one of a plurality of devices in a support infrastructure system of the data center that support the functionality of one or more IT devices in the data center;
if IMS determines that the the condition of the support device is not in a desired state after the procedure is performed, transmit an alert from the IMS to the CMS; and
if the IMS determines that the condition of the support device is in the desired state after the procedure is performed, transmit a verification message from the IMS to the CMS instructing the CMS to close closing the work ticket.

10. The computer program product of claim 9, wherein the IT devices at least one of move, store, and manipulate data in response to client requests received at the data center.

11. The computer program product of claim 9, further comprising computer-readable program code configured to:
receive at the CMS a signal from a technician, the signal indicating that the procedure was performed;
upon receiving the signal, transmit from the CMS to the IMS the request to confirm that the procedure was performed properly.

12. The computer program product of claim 11, further comprising computer-readable program code configured to, before receiving the signal from the technician, display a visual indicator on the support device viewable to the technician that uniquely identifies the support device from the plurality of devices in the support infrastructure system.

13. The computer program product of claim 9, further comprising computer-readable program code configured to, if the IMS determines that the condition of the support device is not the desired state, issue a new work ticket from the CMS, the new work ticket comprising a new procedure for changing the condition of the support device to the desired state.

14. The computer program product of claim 9, further comprising computer-readable program code configured to, if the IMS determines that the condition of the support device is not the desired state, changing the condition of the support device to the desired state using the IMS.

15. The computer program product of claim 9, wherein the condition of the support device comprises at least one of: an operational mode of the support device and a functional status of the support device.

16. The computer program product of claim 9, wherein the support device at least one of (i) provides power to an IT device in the data center configured to process data associated with a client request received at the data center and (ii) alters an environmental condition of the data center to achieve a desired value of the environmental condition.

17. A system, comprising:
a change management system (CMS) configured to issue a work ticket, the work ticket specifies a procedure that alters a condition of a support device in the data center;
a support device in a data center, wherein the support device is one of a plurality of devices in a support infrastructure system of the data center that support the functionality of one or more IT devices in the data center; and
a infrastructure management system (IMS) communicatively coupled to the support device, wherein the IMS is configured to, upon receiving a request from the CMS to confirm that the procedure was performed properly, determine the condition of the support device in the data center,
wherein if the IMS determines that the condition of the support device is not in a desired state after the procedure is performed, the IMS is configured to transmit an alert to the CMS, and
wherein, if the IMS determines that the condition of the support device is in the desired state after the procedure is performed, the IMS is configured to transmit a verification message to the CMS instructing the CMS to close the work ticket.

18. The system of claim 17, wherein the IT devices at least one of move, store, and manipulate data in response to client requests received at the data center.

19. The system of claim 17, wherein the CMS is configured to receive a signal from a technician, the signal indicating that the procedure was performed, and the CMS is configured to, upon receiving the signal, transmit to the IMS the request to confirm that the procedure was performed properly.

20. The system of claim 17, further comprising, if the IMS determines that the condition of the support device is not the desired state, the CMS is configured to issue a new work ticket, the new work ticket comprising a new procedure for changing the condition of the support device to the desired state.

21. The system of claim 17, wherein if the IMS determines that the condition of the support device is not the desired state, the IMS is configured to change the condition of the support device to the desired state.

22. The system of claim 17, wherein the condition of the support device comprises at least one of: an operational mode of the support device and a functional status of the support device.

23. The system of claim 17, wherein the support device is configured to at least one of (i) provide power to an IT device in the data center configured to process data associated with a client request received at the data center and (ii) alter an environmental condition of the data center to achieve a desired value of the environmental condition.
